(19) United States
(12) Patent Application Publication
(10) Pub. No.: US 2015/0188861 A1
(43) Pub. Date: Jul. 2, 2015

(54) MECHANISM FOR FACILITATING DYNAMIC GENERATION AND TRANSMISSION OF CANNED RESPONSES ON COMPUTING DEVICES

(71) Applicants: Aaren Esplin, Portland, OR (US); Kofi Whitney, Hillsboro, OR (US); Noah Dijulio, Portland, OR (US); Jooyoung Oh, Portland, OR (US); In Baek, Troutdale, OR (US); Isabel Bush, Portland, OR (US)

(72) Inventors: Aaren Esplin, Portland, OR (US); Kofi Whitney, Hillsboro, OR (US); Noah Dijulio, Portland, OR (US); Jooyoung Oh, Portland, OR (US); In Baek, Troutdale, OR (US); Isabel Bush, Portland, OR (US)

(21) Appl. No.: 14/140,641

(22) Filed: Dec. 26, 2013

(51) Int. Cl. H04L 12/58; H04W 4/14

(52) U.S. Cl. CPC H04L 51/06; H04W 4/14

(57) ABSTRACT

A mechanism is described for facilitating a dynamic selection and transmission of canned messages according to one embodiment. A method of embodiments, as described herein, includes selecting, at a computing device, a canned message from a plurality of canned messages, where the canned message includes a text message having one or more of a default message, a variable, and a symbol, wherein the selection is to be performed without a keyboard at the computing device, and transmitting the selected canned message.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

Embodiments described herein generally relate to computers. More particularly, embodiments relate to a mechanism for facilitating dynamic generation and transmission of canned responses on computing devices.

### BACKGROUND

Conventional messaging techniques require a keyboard (e.g., a physical keyboard, a displayed/virtual keyboard) for a user to type a message, such as an email or a text message. However, in requiring manual typing of messages, these conventional techniques are not only inefficient and time-consuming, but also, often, not available on smaller computing devices that are too small to display a keyboard.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a dynamic canned messaging mechanism at a computing device according to one embodiment.

FIG. 2A illustrates a dynamic canned messaging mechanism according to one embodiment.

FIG. 2B illustrates a transaction sequence canned messages using dynamic canned messaging mechanism of FIG. 2A according to one embodiment.

FIGS. 2C-2H illustrate screenshots for showing editing and customization of canned messages using dynamic canned messaging mechanism of FIG. 2A according to one embodiment.

FIG. 3 illustrates a method for facilitating a dynamic canned messaging mechanism at a computing device according to one embodiment.

FIG. 4 illustrates computer system suitable for implementing embodiments of the present disclosure according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for a novel and innovative technique for dynamically and automatically-drafted canned message to be quickly and efficiently transmitted from one computing device (e.g., wearable device (such as a bracelet, a watch, etc.), mobile computer (such as a smartphone, tablet computer, etc.)) to another computing device without having to require a keyboard. Embodiments further provide for an intelligent and dynamic selection of canned messages based on any number and type of factors, such as user history, other user's identity, type of communication (e.g., work, personal, etc.), language of communication, content and/or context sensitivity, etc.

It is contemplated and to be noted that canned messages neither depend on nor have to in response to one or more incoming messages. Although in this document, as an example and for brevity, clarity, and ease of understanding, canned messages are often discussed in relation or response to an incoming message, embodiments are not limited as such and that a canned response may be independently generated for any or no reason and may itself serve as an incoming message at the received computing device.

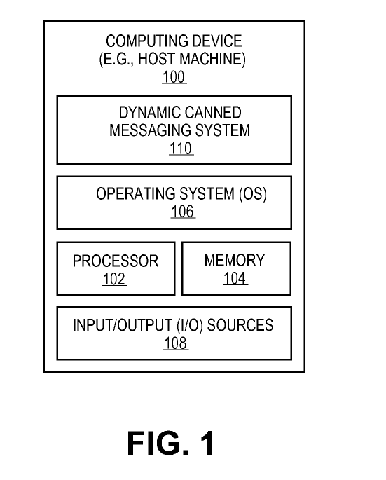

FIG. 1 illustrates a dynamic canned messaging mechanism 110 at a computing device 100 according to one embodiment. Computing device 100 serves as a host machine for hosting dynamic canned messaging mechanism (“messaging mechanism”) 110 that includes a combination of any number and type of components for facilitating dynamic and automatic drafting, sending, and receiving of canned messages at computing device 100.

Computing device 100 may include large computing systems, such as server computers, desktop computers, etc., and may further include set-top boxes (e.g., Internet-based cable television set-top boxes, etc.), global positioning system (GPS)-based devices, etc. Computing device 100 may include mobile computing devices, such as cellular phones including smartphones (e.g., iPhone® by Apple®, BlackBerry® by Research in Motion®, etc.), personal digital assistants (PDAs), tablet computers (e.g., iPad® by Apple®, Galaxy 3® by Samsung®, etc.), laptop computers (e.g., notebook, netbook, an Ultrabook™ system, etc.), e-readers (e.g., Kindle® by Amazon®, Nook® by Barnes and Nobles®, etc.), smart televisions, wearable devices (e.g., watches, bracelets, smartcards, etc.), media players, etc.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc. It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, and “software package” may be used interchangeably throughout this document. Similarly, terms like “job”, “input”, “request” and “message” may be used interchangeably throughout this document.

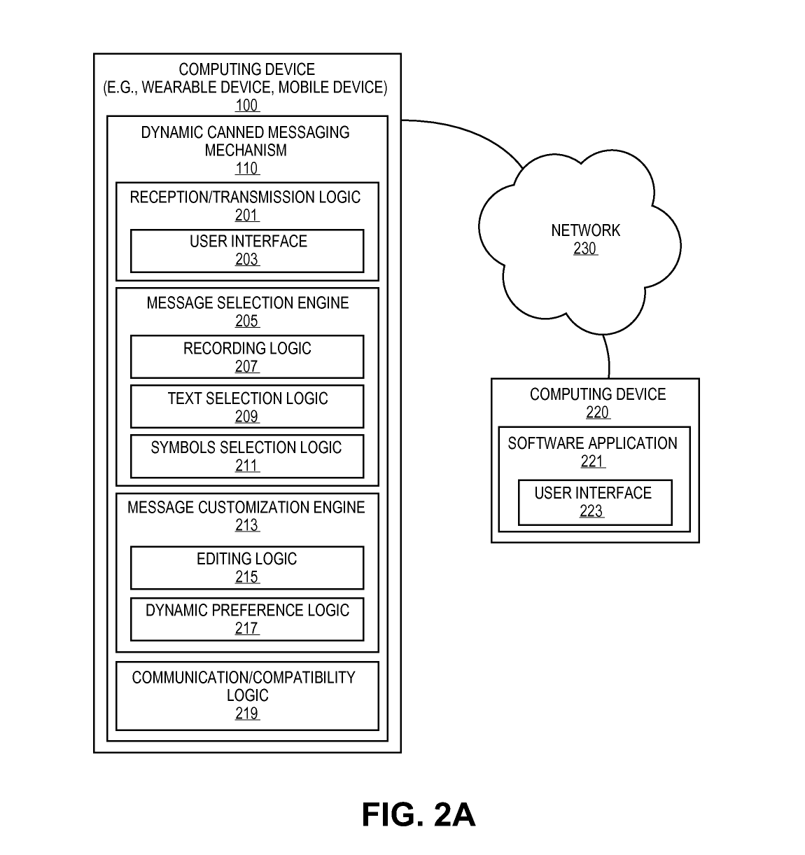

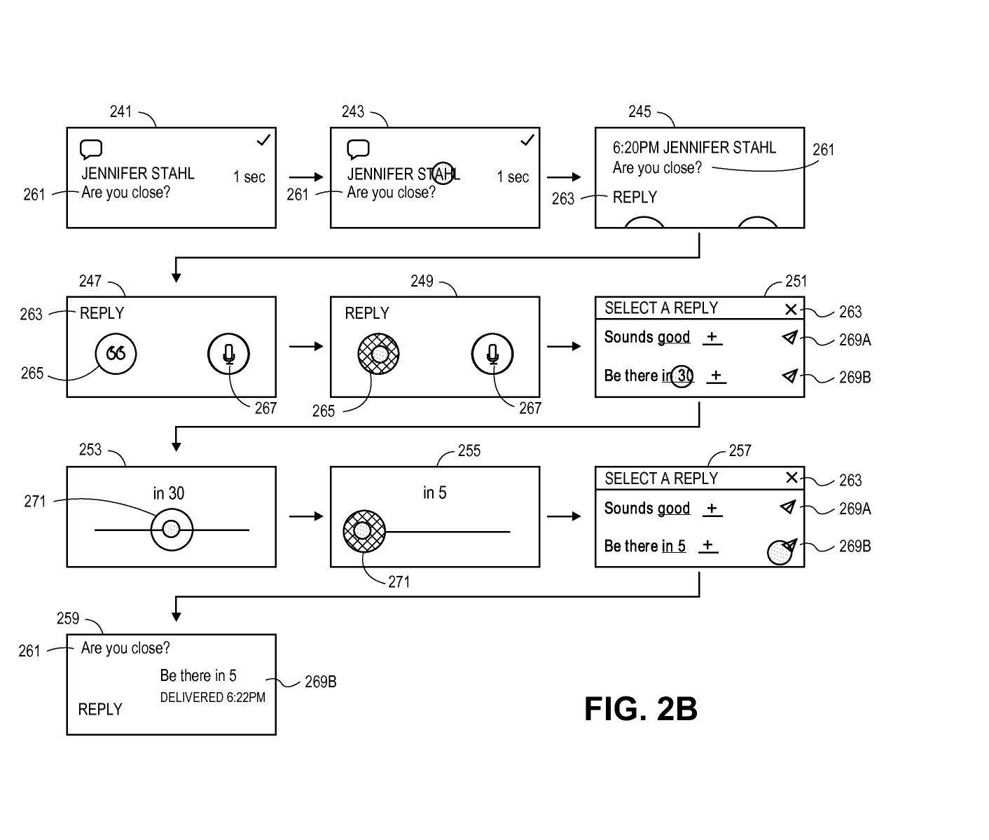

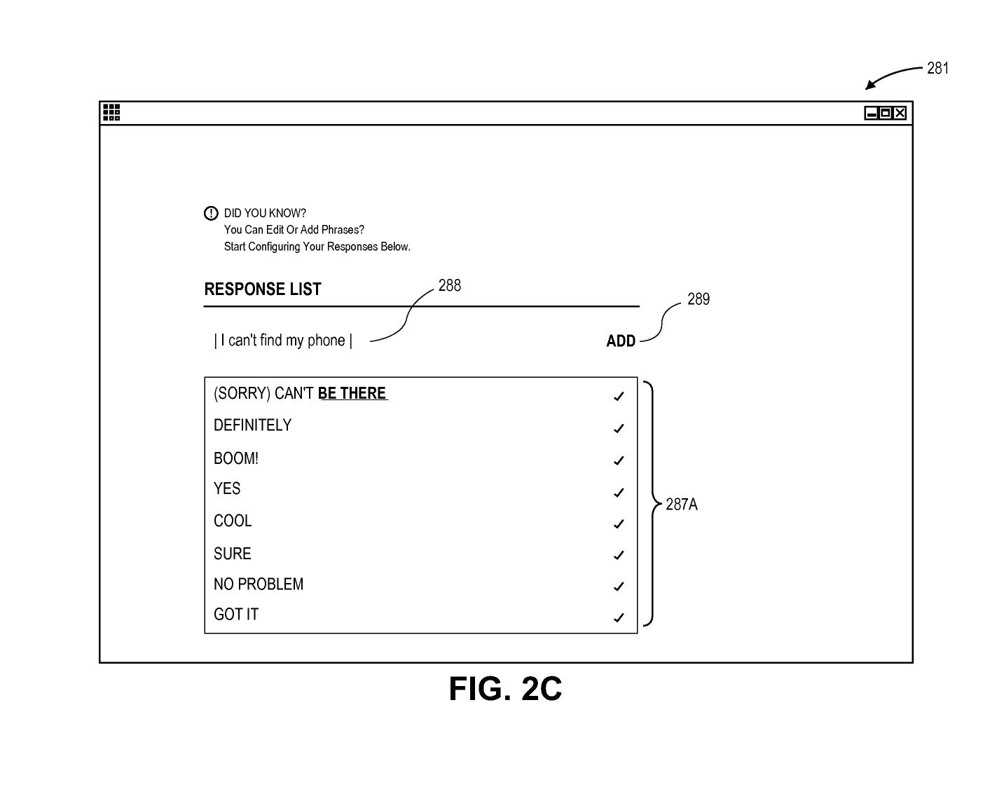

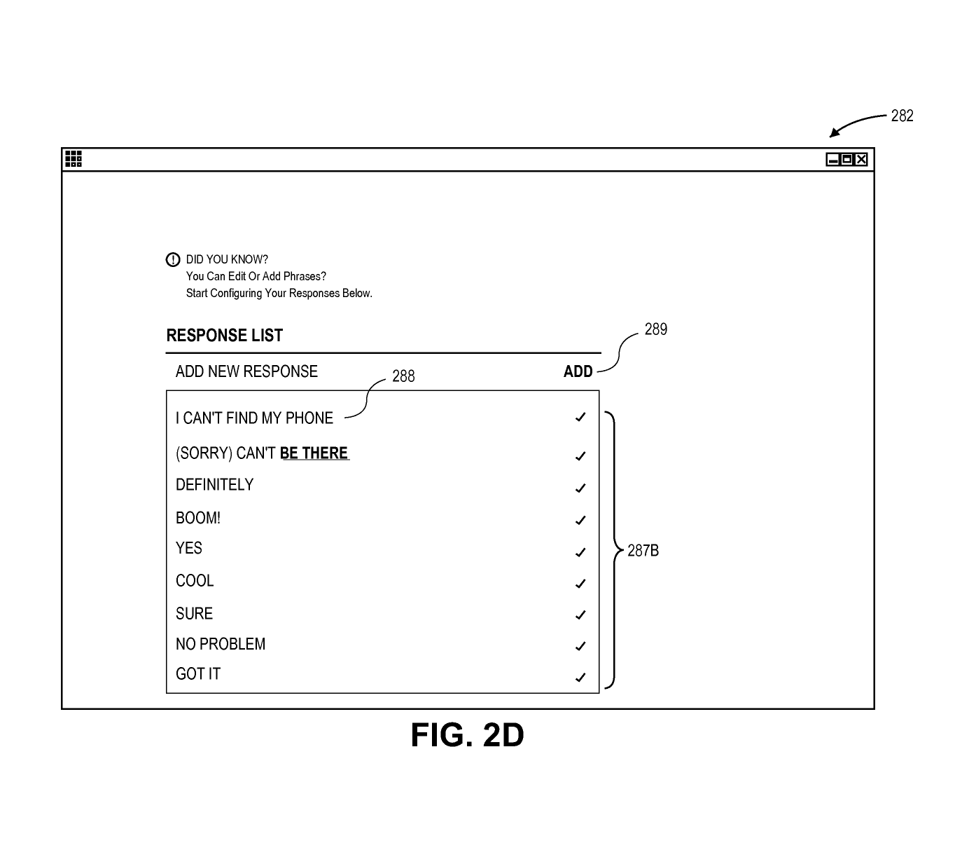

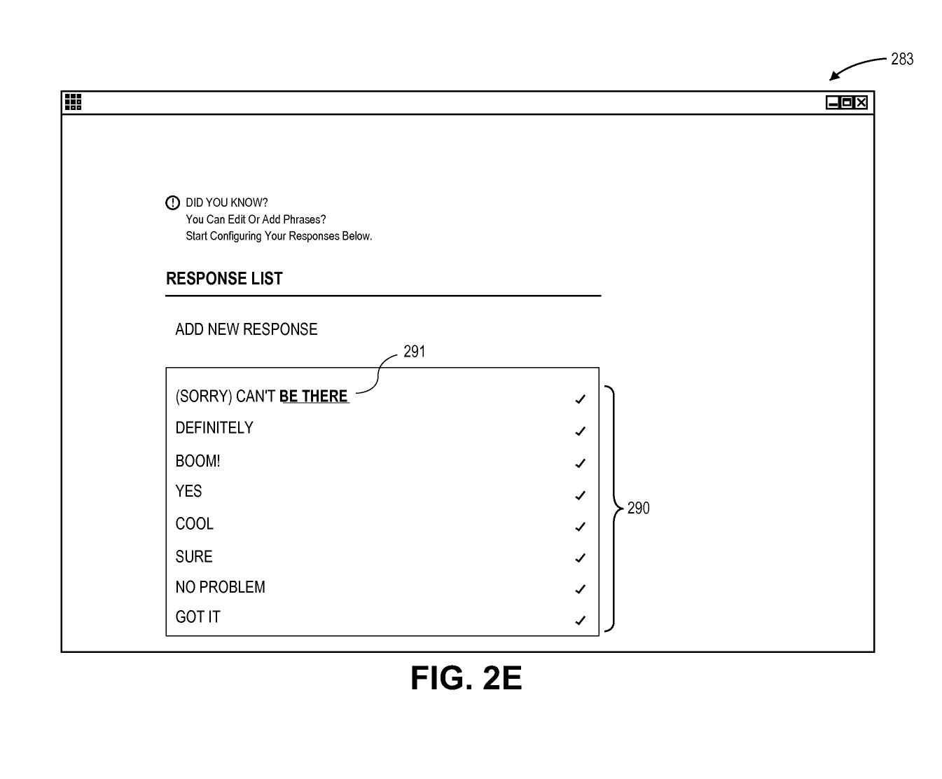

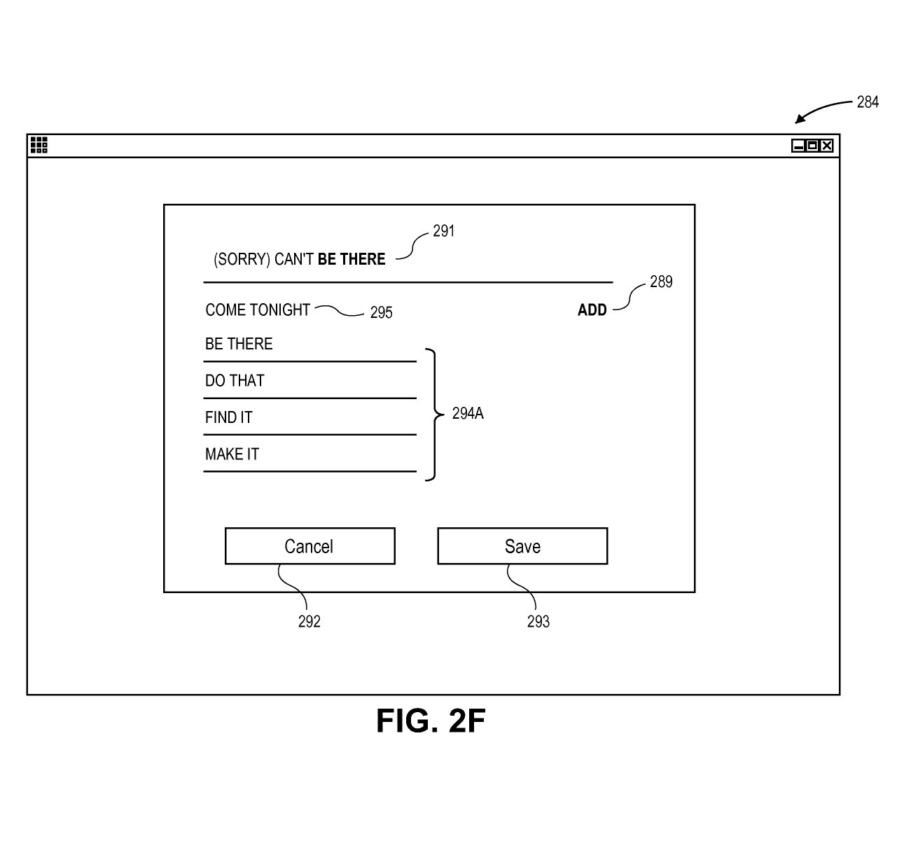

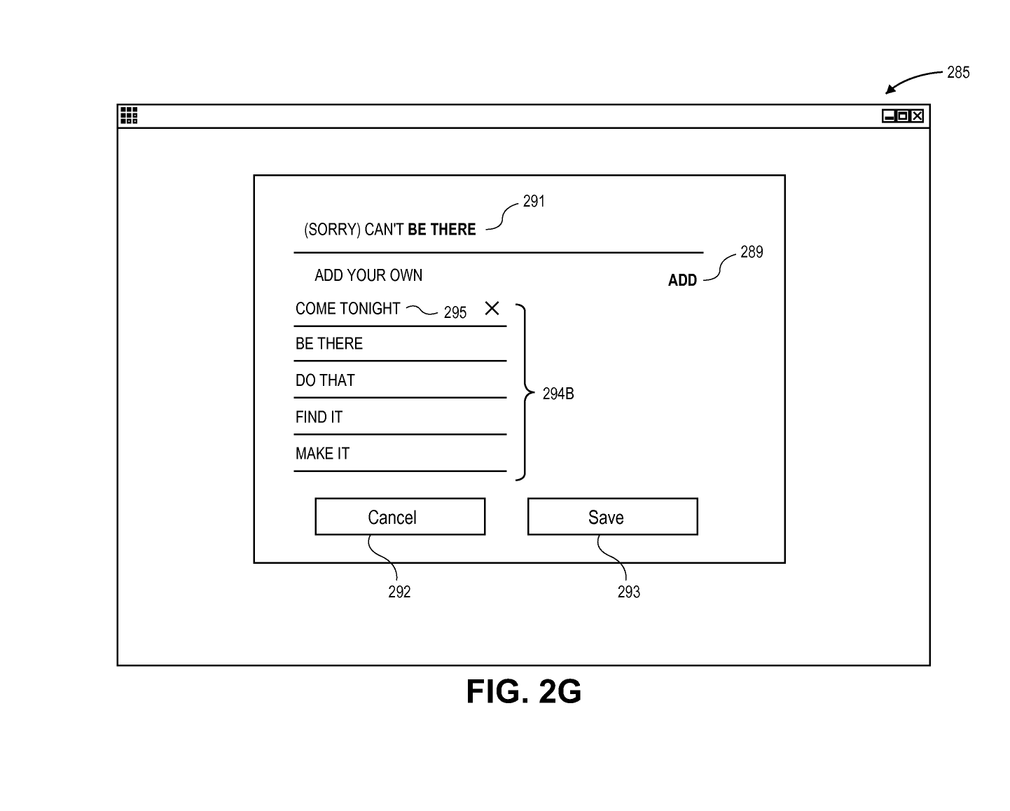

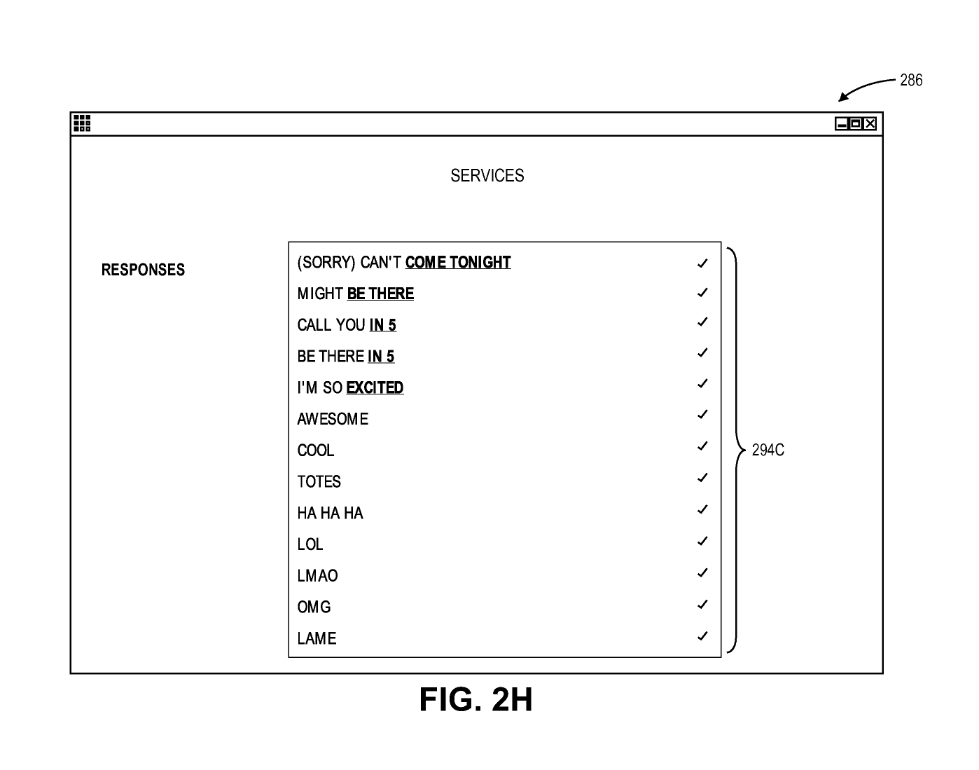

FIG. 2A illustrates a dynamic canned messaging mechanism 110 according to one embodiment. In one embodiment, messaging mechanism 110 may be employed at computing device 100 serving as a host machine, such as a wearable computing device, a smartphone, a tablet computer, etc. In one embodiment, messaging mechanism 110 includes one or more components, such as: reception/transmission logic 201 including user interface 203; message selection engine 205 including recording logic 207, text selection logic 209 and symbols selection logic 211; message customization engine 213 including editing logic 215 and dynamic preference logic 217; and communication/compatibility logic 219.

In one embodiment, for example, messaging mechanism 110 includes reception/transmission logic 201 to receive a message from a computing device, such as computing device 220, to which a canned response may be dynamically selected at computing device 100 and transmitted back to the computing device 220 over a network, such as network 230 (e.g., Internet, cloud network, proximity network, etc.). It is to be noted that reception/transmission logic 201 may include reception logic and/or transmission logic each of which may include software (e.g., software program) and/or hardware (e.g., hardware circuitry) to perform one or tasks relating to receiving and/or transmitting of canned messages, regular messages, etc. It is contemplated that embodiments are not limited to providing canned message merely in response to a received message, but that any number and type of canned message may be selected at computing device 100 and transmitted to any number and type of other computing devices, such as computing device 220, as “initial messages” or “initiating messages” (as opposed to “responses” or “replies”) being independent of and without having to rely on or receive or be in response/reply to any other messages. However, for the sake of brevity, clarify, and ease of understanding, throughout this document, canned messages may be termed as responses or replies to incoming messages, but embodiments are not limited as such.

Similarly, as aforementioned, computing devices 100, 220 are not limited to any particular number and type of computing devices, but for the sake of brevity, clarify, and ease of understanding, throughout this document, computing devices 100, 220 are referred to as wearable computing devices (such as watches, bracelets, smartcards, smart badges, glasses, headsets, necklaces, and clothes or clothing items, etc.) or mobile computing devices (such as smartphones, tablet computers, etc.), but embodiments are not limited as such. It is contemplated that since most wearable devices may be too small to display a keyboard that canned messages such as the ones described here are more likely to be used with wearable devices, but they are not limited to wearable devices or mobile computers and that canned messages may be selected on, received at and/or transmitted from any number and type of computing devices, such as a desktop computer, a laptop computer, etc.

Referring back to the example, upon receiving a message at computing device 100 from computing device 220 where the message may have been placed via user interface 223 of messaging software application 221 (e.g., short message service (SMS) or texting application, email application, etc.), the user of computing device 100 may choose to respond, via user interface 203, to the received message with a canned message. In some embodiments and for example, software application 221 may include any number and type of communication software applications or websites (such as iMessage® by Apple®, Skype®, Viber®, Tango®, Outlook® by Microsoft®, Google Mail® from Google®, etc.), social and/or business networking websites (such as Facebook®, Twitter®, LinkedIn®, etc.), etc. Similarly, user interfaces 203, 223 may include any number and type of user interfaces, such as web user interface (WUI), graphical user interface (GUI), touchscreen, etc., that may be provided via a display screen.

As will be further described with respect to FIG. 2B-2H, for example, the received messages may include a text from a friend inquiring “are you close?” and upon receiving the message, the user of computing device 100 may choose to respond either through voice or written message. For example, in one embodiment, the user may choose to click on a microphone icon to record a voice response and transmit it over to computing device 200 over network 230. In another embodiment, the user may choose to select a message from a list of canned message, such as “be there ______” to respond to the incoming message. For example, the “be there” part of “be there in 5” may be one of many default canned phrases to choose from, allowing the user to simply choose a variable, such as a number representing time, to complete the messages, such as “be there in 5” where “5” or “in 5” represents 5 minutes. It is contemplated that variables are not limited in anyway, such as time may not be limited to simply minutes and that the response may be provided in terms of seconds, minutes, hours, days, weeks, etc., and that embodiments are not limited as such. Further, continuing with the example, the “5” may be chosen by the user from any number of options, such as 5, 10, 15, 30, etc., by simply touching or clicking on the “5” on the display screen or selecting from a drop down-like menu or from a sliding bar as shown with reference to FIGS. 2B-2H, or the like.

In one embodiment, if the user chooses to record a voice message (e.g., audio and/or video message), recording logic 207 of message selection engine 205 may facilitate the recording of the voice message which may then be transmitted to computing device 220 via reception/transmission logic 201. Similarly, if the user chooses to respond by selecting a canned message, text selection logic 209 may facilitate the selection of a canned response, such as “Be there is 5”, where the first part of the response (e.g., “Be there” or “Be there in”) may be selected from a set of default phrases, while the second part (e.g., “in 5” or “5”, respectively) may be selected from a set of variables.

In one embodiment, in additional to the sets of default phrases and variables, a set of symbols (e.g., punctuations, emoticons, etc.) may also be provided for the user to choose one or more punctuation marks and/or emoticons to convey certain emotions/feelings in response to the incoming message. For example, the user may choose to add a punctuation mark (e.g., an exclamation point) and/or an emoticon (e.g., a smiley face) to the canned response, such as “Be there in 5!”, “Be there in 5 [symbol] ”, “Be there in 5! [symbol] ”, or the like. In one embodiment, symbols selection logic 211 may facilitate the selection of any number and type of symbols to be part of the canned message.

In one embodiment, message customization logic 211 may be used to customize canned responses as desired or necessitated. For example, the user may choose to add, delete, and/or modify any number and type of default messages, variables, and/or symbols. In one embodiment, a software application, such as a website, may be used for making the aforementioned changes. For example, as will be further described with reference to FIGS. 2B-2H, the user may access the website as facilitated by editing logic 215 to delete or modify any part of any of the existing canned messages, such as the default part of a message, the variable part of the message, and/or the symbol part of the message. Although a set of default messages may be provided as part a software package, in some embodiments, user may be allowed to change any of the default messages along with any of the variables and/or symbols. Similarly, in addition to deletions and modifications, any number and type of default messages, variables, and/or symbols may be added to the existing lists as desired or necessitated by the user. For example, the user may choose to add a default message, a variable and/or a symbol that may be sufficiently informal to be suited for a particular individual, such as a close friend or family of the user, etc.

In one embodiment, dynamic preference logic 217 may be used to automatically and dynamically generate and transmit preferred canned messages. For example, in one embodiment, dynamic preference logic 217 may detect any number of factors relating to an incoming message, such as (but not limited to) (1) the user's historical pattern of sending canned messages (such as sending the same canned message to the user of a particular computing device, such as computing device 220), (2) context (such as a message sent during vacation or office hours, a message sent during the day or late at night, etc.) and/or content (e.g., a business message, a personal message, etc.) of incoming messages, (3) sensitivity of the language of the incoming message (e.g., informal/playful language, formal/business language, children-like language, etc.), and (4) type or ownership of the computing device initiating the incoming message (such as wife's bracelet, husband's watch, office computer, manager's smartcard, etc.), or the like.

In one embodiment, the aforementioned and other relevant factors may be detected and subsequently used by dynamic preference logic 217 to automatically and dynamically recommend a canned response to be selected by message selection logic 205 and transmitted on to computing device 220. For example, dynamic preference logic 217 may dynamically and automatically recommend a preferred canned response (e.g., “sure, thanks!”) to be selected by message selection logic 205 and subsequently transmitted in response to an incoming message (e.g., “daily staff meeting at 2 PM?”) initiated from a known computing device (e.g., finance manager's smartcard being represented as computing device 220) based on a historical pattern of message communication between computing devices 100 and 220.

Similarly, in some embodiments, it is contemplated that message customization engine 213, such as dynamic preference logic 217, may work with one or more local components of computing device to perform detection and determination of content and/or context relating to incoming and/or canned messages. Computing devices 100, 220 may further include any number and type of touch/image components including (but not limited to) image capturing devices (e.g., one or more cameras, etc.) and other sensing devices, such as (but not limited to) context-aware sensors (e.g., temperature sensors, facial expression and feature measurement sensors working with one or more cameras, environment sensors (such as to sense background colors, lights, etc.), biometric sensors (such as to detect fingerprints, facial points or features, etc.), and the like). As aforementioned, computing devices 100, 220 may also include one or more software applications, such as business applications, social network websites (e.g., Facebook®, Google+®, Twitter®, etc.), business networking websites (e.g., LinkedIn®, etc.), communication applications (e.g., Skype®, Tango®, Viber®, etc.), games and other entertainment applications, etc., offering one or more user interfaces (e.g., WUI, GUI, touchscreen, etc.) via a display screen, while ensuring compatibility with changing technologies, parameters, protocols, standards, etc.

Communication/compatibility logic 219 may be used to facilitate dynamic communication and compatibility between computing device 100 (such as a wearable computing device, a mobile computing device, a laptop computer, etc.) and any number and type of other computing devices (e.g., computing device 220, such as a wearable computing device, a mobile computing device, a desktop computer, a server computing device, etc.), storage devices, databases and/or data sources (such as data storage devices, hard drives, solid-state drives, hard disks, memory cards or devices, memory circuits, etc.), networks, such as network 230 (e.g., cloud network, the Internet, intranet, cellular network, proximity networks, such as Bluetooth®, Bluetooth® low energy (BLE), Bluetooth® Smart, Wi-Fi® proximity, Radio Frequency Identification (RFID), Near Field Communication (NFC), Body Area Network (BAN), etc.), wireless or wired communications and relevant protocols (e.g., Wi-Fi®, WiMAX®, Ethernet, etc.), connectivity and location management techniques, software applications/websites, (e.g., social and/or business networking websites, such as Facebook®, LinkedIn®, Google+®, Twitter®, etc., business applications, games and other entertainment applications, etc.), programming languages, etc., while ensuring compatibility with changing technologies, parameters, protocols, standards, etc.

Although one or more examples (e.g., incoming messages, such as texts or emails, etc., canned messages including one or more of a default message, a variable, and/or a symbol, etc., business and/or social networking websites, wearable computers, smartphones, table computers, etc.) may be discussed throughout this document for brevity, clarity, and ease of understanding, it is contemplated that embodiments are not limited to any particular number and type of gestures, display panels, computing devices, users, network or authentication protocols or processes, or the like. For example, embodiments are not limited to any particular network security infrastructures or protocols (e.g., single-sign-on (SSO) infrastructures and protocols) and may be compatible with any number and type of network security infrastructures and protocols, such as security assertion markup language (SAML), OAuth, Kerberos, etc.

Throughout this document, terms like “logic”, “component”, “module”, “framework”, “engine”, “point”, and the like, may be referenced interchangeably and include, by way of example, software, hardware, and/or any combination of software and hardware, such as firmware. Further, any use of a particular brand, word, term, phrase, name, and/or acronym, such as “canned message”, “default message”, “variables”, “symbols”, “punctuation mark”, “emoticon”, “customization”, “editing”, “wearable device”, “bracelet”, “watch”, “smartcard”, etc., should not be read to limit embodiments to software or devices that carry that label in products or in literature external to this document.

It is contemplated that any number and type of components may be added to and/or removed from dynamic canned messaging mechanism 110 to facilitate various embodiments including adding, removing, and/or enhancing certain features. For brevity, clarity, and ease of understanding of dynamic canned messaging mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

FIG. 2B illustrates a transaction sequence 240 canned messages using dynamic canned messaging mechanism 110 of FIG. 2A according to one embodiment. In one embodiment, at block 241, incoming message 261 is received (from a second computing device, such as computing device 220 of FIG. 2A) at a first computing device (e.g., wearable computing device, mobile computer, etc.), such as computing device 100 of FIG. 2A, and is displayed via a user interface, such as user interface 203 of FIG. 2A, that is provided through a display screen of the computing device. In the illustrated embodiment, the incoming message 261, received from a second user, such as a friend named Jennifer Stahl associated with the second computing device, recites or inquires “are you close?” which may refer to whether the first user associated with the first computing device has reached a destination. At block 243, the first user may simply touch or click on the incoming message 261 to initiate a quick response/reply using one or more canned messages as facilitated by dynamic canned messaging mechanism 110 of FIG. 2A. At block 245, reply options 263 are shown to be appearing on the display screen for the user to select a canned message response.

At block 247, reply options 263 have fully appeared, displaying, for example, a couple of reply options, such as text response option 265 and audio response option 267. The first user may choose to select either response option, such as touch or click on audio option 267 to record a voice message in reply to incoming message 261. It is contemplated that in some embodiments, audio option 267 may not be limited to recording an audio/voice response and that the first user may be offered to record an audio/voice response, a video response, an animation response (such as using an avatar), or any combination thereof. At block 249, text response option 265 is shown to have been chosen by the first user.

In response to choosing text response option 265, at block 251, the first user may be provided a list having any number and type of canned messages 269A, 269B to select from to respond to incoming message 261. In the illustrated embodiment, a list of canned messages 269A, 269B are provided of which, for example, the first user selects canned message 269B to response to incoming message 261 by simply touching or clicking on canned message 269B. As aforementioned, in some embodiments, a canned message may include (1) a default message (represented by and illustrated as “Sounds” in case of canned message 269A and “Be there” in case of canned message 269B), (2) a variable (represented by and illustrated as a blank or “______” in canned messages 269A, 269B) to be added by the first user by selecting one from a list of variables (e.g., default variables, user-provided variables, etc.) or by simply typing one in, and/or (3) a symbol (represented by and illustrated as “+” in canned messages 269A, 269B). Further, at block 251, the first user is shown to have chosen canned message 269B.

At block 253, in one embodiment, the display screen of the first computing device displays time slide/bar 271 which the first user may use or manipulate to select a number representing, in this example, time in minutes. At block 255, for example, the first user chooses to set time slide/bar 271 at 5 minutes to fill in the variable part of canned message 269B as shown in block 257, which now recites “Be there in 5+”. In the illustrated embodiment, the first user decides not to include any symbols in canned message 269B and decides to settle for “Be there in 5” as shown in block 259. Further, in block 259, canned message 269B (e.g., “Be there in 5”) is transmitted as reply 263 to incoming message 261 (e.g., “Are you close?”). It is contemplated that incoming message 261, canned messages 269A, 269B, text and audio options 265, 267, time slide/bar 271, and the like, are merely provided as examples for brevity, clarify, and ease of understanding and that embodiments are not limited to such examples.

FIGS. 2C-2H illustrate screenshots 281-286 for showing editing and customization of canned messages using dynamic canned messaging mechanism 110 of FIG. 2A according to one embodiment. In one embodiment, a software application, such as a website, may be used for editing and customization of canned messages. In the illustrated embodiment of FIG. 2C, screenshot 281 shows a page for adding a canned message 288 (e.g., “I can't find my phone”) to an already existing list 287A of canned messages simply typing the canned message 288 and then clicking on an add button, such as add 289. Consequently, FIG. 2D provides screenshot 282 which illustrates the new canned message 288 being added to and now part of the newly-updated list 287B of canned messages.

FIG. 2E illustrates screenshot 283 having a list 290 of canned messages. In one embodiment, a canned message 291 from the list 290 may be selected for customization such that the selected canned message 291 (e.g., “(Sony) Can't be there”) may be used to reply to any number of incoming messages. FIG. 2F illustrates a list 294A of variables that may be selected or chosen to replace the “be there” variable of the selected canned message 291 (e.g., “(Sorry) Can't be there”), such as “(Sorry) Can't find it” or “(Sorry) Can't do that”, or the like. A new variable 295, such as “come tonight”, may be added to list 294A and upon adding the new variable, either save 293 may be clicked to save the message and complete the transaction or cancel 292 may be clicked to cancel the transaction. If the new variable successfully added, it may become part of variable list 294A of FIG. 2F which is then updated or transformed into a newly-updated variable list 294B of FIG. 2G that includes the newly added variable 295, such as “come tonight”. Further, as illustrated in FIG. 2G, in one embodiment, the selected canned message 291 (e.g., “(Sorry) Can't be there”) may now be dynamically customized by the user to include the newly added variable 295 of “come tonight” from list 294B to replace the current variable “be there” to update canned message 291 to recite “(Sorry) Can't come tonight”.

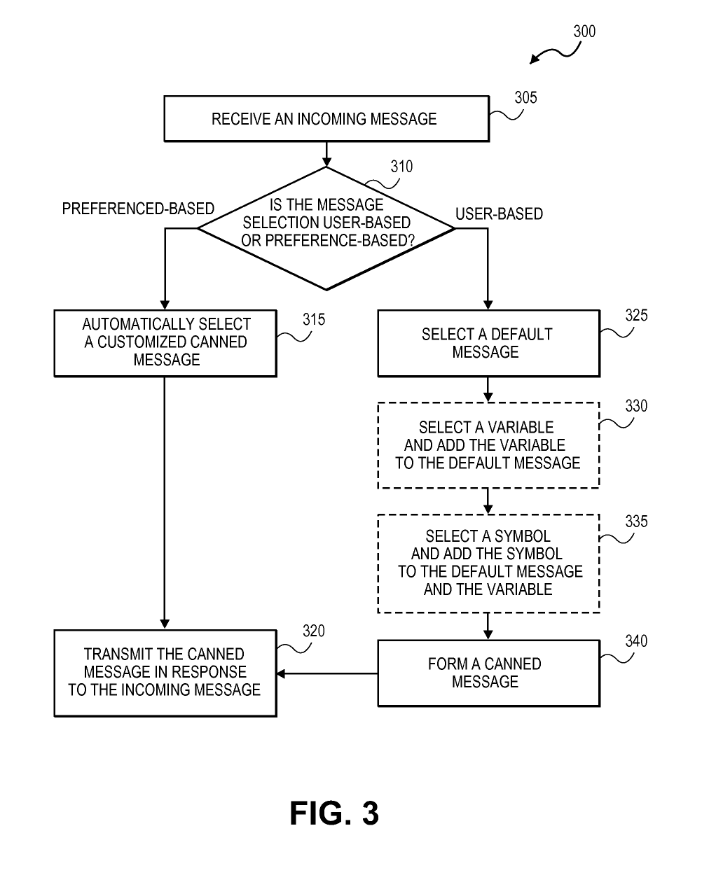

FIG. 3 illustrates a method 300 for facilitating a dynamic canned messaging mechanism 110 at a computing device according to one embodiment. Method 300 may be performed by processing logic that may comprise hardware (e.g., circuitry, dedicated logic, programmable logic, etc.), software (such as instructions run on a processing device), or a combination thereof. In one embodiment, method 300 may be performed by dynamic canned messaging mechanism 110 FIG. 1. The processes of method 300 are illustrated in linear sequences for brevity and clarity in presentation; however, it is contemplated that any number of them can be performed in parallel, asynchronously, or in different orders. For brevity, clarity, and ease of understanding, many of the details discussed with reference to other figures in this document are not discussed or repeated here.

Method 300 begins at processing block 305 with receiving of an incoming message at a first computing device from a second computing device. At block 310, a determination is made as to whether a canned response to the incoming message is to be selected by a user of the first computing device or automatically selected based on preferences. At block 315, if the canned response is to be selected based on preferences, a customized canned response is automatically and dynamically selected. As aforementioned, based on direct user-input and/or automatic detection of user preferences and history, customized canned messages may be generated and stored in a list of canned messages. Further, each canned message may be customized to be used to respond to one or more incoming messages without having the user to go through the selection process. At block 320, an automatically and dynamically selected customized canned response transmitted to the second computing device in response to the incoming message.

Referring back to block 310, if the canned messages are to be selected by the user, at block 325, the user selects a default message from a list of default messages. At block 330, the user may select a variable to be added to the selected default message. At block 335, the user may select a symbol (e.g., punctuation mark, emoticon, etc.) to be added to the selected default message. At block 340, the canned message is formed, where the canned message may include the default message and/or the variable and/or the symbol. At block 320, the formed canned message is sent from the first computing device to the second computing device.

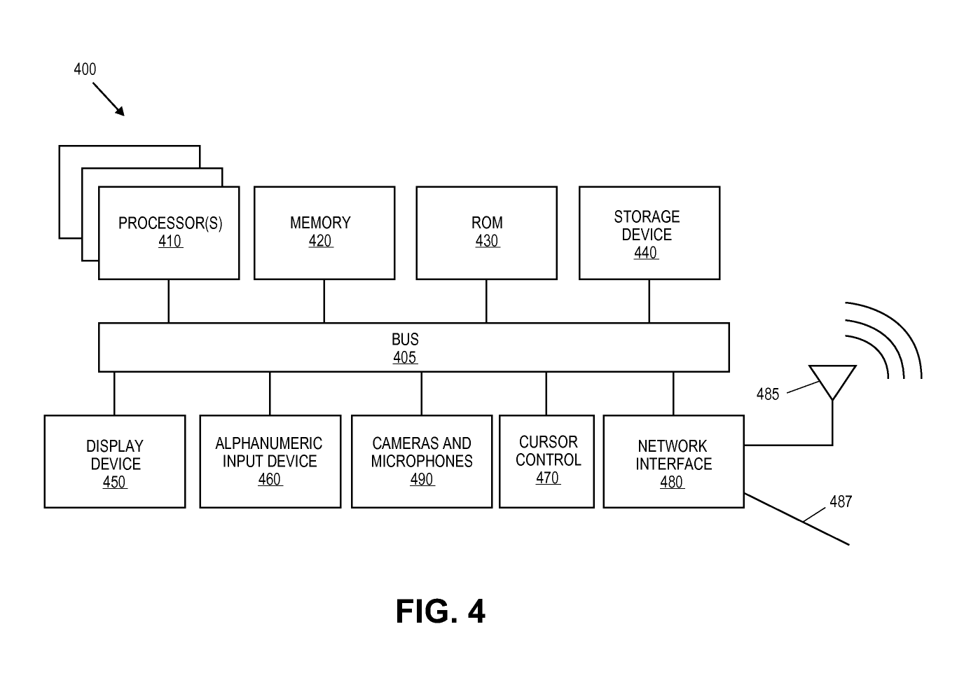

FIG. 4 illustrates an embodiment of a computing system 400. Computing system 400 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, etc. Alternate computing systems may include more, fewer and/or different components. Computing device 400 may be the same as or similar to or include host machine 100 of FIG. 1.

Computing system 400 includes bus 405 (or, for example, a link, an interconnect, or another type of communication device or interface to communicate information) and processor 410 coupled to bus 405 that may process information. While computing system 400 is illustrated with a single processor, electronic system 400 and may include multiple processors and/or co-processors, such as one or more of central processors, graphics processors, and physics processors, etc. Computing system 400 may further include random access memory (RAM) or other dynamic storage device 420 (referred to as main memory), coupled to bus 405 and may store information and instructions that may be executed by processor 410. Main memory 420 may also be used to store temporary variables or other intermediate information during execution of instructions by processor 410.

Computing system 400 may also include read only memory (ROM) and/or other storage device 430 coupled to bus 405 that may store static information and instructions for processor 410. Data storage device 440 may be coupled to bus 405 to store information and instructions. Data storage device 440, such as magnetic disk or optical disc and corresponding drive, may be coupled to computing system 400.

Computing system 400 may also be coupled via bus 405 to display device 450, such as a cathode ray tube (CRT), liquid crystal display (LCD) or Organic Light Emitting Diode (OLED) array, to display information to a user. User input device 460, including alphanumeric and other keys, may be coupled to bus 405 to communicate information and command selections to processor 410. Another type of user input device 460 is cursor control 470, such as a mouse, a trackball, a touchscreen, a touchpad, or cursor direction keys to communicate direction information and command selections to processor 410 and to control cursor movement on display 450. Camera and microphone arrays 490 of computer system 400 may be coupled to bus 405 to observe gestures, record audio and video and to receive and transmit visual and audio commands.

Computing system 400 may further include network interface(s) 480 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 480 may include, for example, a wireless network interface having antenna 485, which may represent one or more antenna(e). Network interface(s) 480 may also include, for example, a wired network interface to communicate with remote devices via network cable 487, which may be, for example, an Ethernet cable, a coaxial cable, a fiber optic cable, a serial cable, or a parallel cable.

Network interface(s) 480 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 480 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 480 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 400 may vary from implementation to implementation depending upon numerous factors, such as price constraints, performance requirements, technological improvements, or other circumstances. Examples of the electronic device or computer system 400 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate a dynamic selection and transmission of canned messages, comprising: message selection logic, at least a portion of which is implemented in hardware, to select, at the apparatus, a canned message from a plurality of canned messages, wherein the canned message includes a text message having one or more of a default message, a variable, and a symbol, wherein the selection is to be performed without a keyboard at the apparatus; and logic, at least a portion of which is implemented in hardware, to transmit the selected canned message.

Example 2 includes the subject matter of Example 1, comprises a computing device including one or more of a wearable computing device or a mobile computing device, wherein the wearable computing device includes one or more of a watch, a bracelet, a smartphone, a smart badge, a pair of glasses, a headset, a necklace, and a clothing item, and wherein the mobile computing device includes one or more of a smartphone, a tablet computer, and a laptop computer.

Example 3 includes the subject matter of Example 1, wherein the canned message further comprises an audio message or a video canned message, and wherein the message selection logic comprises logic to select or record the audio message or the video message.

Example 4 includes the subject matter of Example 1, wherein the message selection logic further comprises text selection logic, at least a portion of which is implemented in hardware, to select the default message from a plurality of default messages, wherein the text selection logic is further to select a value from a plurality of values associated with the variable from a plurality of variables, wherein the variable is to be added to the default message.

Example 5 includes the subject matter of Example 1 or 4, wherein the message selection logic, at least a portion of which is implemented in hardware, further comprises symbol selection logic, at least a portion of which is implemented in hardware, to select the symbol from a plurality of symbols, wherein the symbol is to be added to the default message and the variable, the symbol including one or more of a punctuation mark, an emoticon, and an avatar.

Example 6 includes the subject matter of Example 1, wherein the canned message is to be transmitted in response to an incoming message, wherein the logic is further to receive the incoming message prior to the selection of the canned message.

Example 7 includes the subject matter of Example 4, further comprising message customization logic comprising editing logic, at least a portion of which is implemented in hardware, to edit the plurality of default messages or the plurality of variables, wherein to edit includes to delete or modify the plurality of default messages and the plurality of variables, and wherein to edit further includes to add one or more default messages to the plurality of default messages or one or more variables to the plurality of variables.

Example 8 includes the subject matter of Example 5 or 7, wherein the editing logic further allows for editing the plurality of symbols, wherein editing includes deleting or modifying the plurality of symbols, and wherein editing further includes adding one or more symbols to the plurality of symbols.

Example 9 includes the subject matter of Example 1 or 7, wherein the message customization logic, at least a portion of which is implemented in hardware, further comprises dynamic preference logic to determine a preferred canned message to be selected and transmitted in response to the incoming message, wherein to determine includes to detect one or more of user preferences, user history, sender-user identification, sending-computing device identification, language sensitivity of the incoming messages, time sensitivity relating to the incoming messages, context relating to the incoming message, and content of the incoming message.

Example 10 includes the subject matter of Example 9, wherein the dynamic preference logic is further to correspond one or more of the canned messages to one or more of the incoming messages, and wherein the dynamic preference logic is further to facilitate the message selection logic to select and transmit a preferred canned message in response to a corresponding incoming message.

Some embodiments pertain to Example 11 that includes a method for facilitating a dynamic selection and transmission of canned messages, comprising: selecting, at a computing device, a canned message from a plurality of canned messages, wherein the canned message includes a text message having one or more of a default message, a variable, and a symbol, wherein the selection is to be performed without a keyboard at the computing device; and transmitting the selected canned message.

Example 12 includes the subject matter of Example 11, wherein the computing device comprises one or more of a wearable computing device or a mobile computing device, wherein the wearable computing device includes one or more of a watch, a bracelet, a smartphone, a smart badge, a pair of glasses, a headset, a necklace, and a clothing item, and wherein the mobile computing device includes one or more of a smartphone, a tablet computer, and a laptop computer.

Example 13 includes the subject matter of Example 11, wherein the canned message further comprises an audio message or a video canned message, and further comprising selecting or recording the audio message or the video message.

Example 14 includes the subject matter of Example 11, further comprising selecting the default message from a plurality of default messages, and the variable from a plurality of variables, wherein the variable is to be added to the default message.

Example 15 includes the subject matter of Example 14, further comprising selecting the symbol from a plurality of symbols, wherein the symbol is to be added to the default message and the variable, the symbol including one or more of a punctuation mark, an emoticon, and an avatar.

Example 16 includes the subject matter of Example 15, wherein the canned message is to be transmitted in response to an incoming message, wherein the incoming message is received prior to the selection of the canned message.

Example 17 includes the subject matter of Example 14, further comprising editing the plurality of default messages or the plurality of variables, wherein editing includes deleting or modifying the plurality of default messages and the plurality of variables, and wherein editing further includes adding one or more default messages to the plurality of default messages or one or more variables to the plurality of variables.

Example 18 includes the subject matter of Example 17, wherein editing further comprises editing the plurality of symbols, wherein editing includes deleting or modifying the plurality of symbols, and wherein editing further includes adding one or more symbols to the plurality of symbols.

Example 19 includes the subject matter of Example 11, further comprising determining a preferred canned message to be selected and transmitted in response to the incoming message, wherein determining includes detecting one or more of user preferences, user history, sender-user identification, sending-computing device identification, language sensitivity of the incoming message, time sensitivity relating to the incoming message, context relating to the incoming message, and content of the incoming message.

Example 20 includes the subject matter of Example 19, further comprising: corresponding one or more of the canned messages to one or more of the incoming messages; and facilitating selection and transmission of a preferred canned message in response to a corresponding incoming message.

Example 21 includes at least one machine-readable medium comprising a plurality of instructions that in response to being executed on a computing device, causes the computing device to carry out operations according to any one of the aforementioned examples 11 to 20.

Example 22 includes at least one non-transitory or tangible machine-readable medium comprising a plurality of instructions that in response to being executed on a computing device, causes the computing device to carry out operations according to any one of the aforementioned examples 11 to 20.

Example 23 includes a system comprising a mechanism to carry out operations according to any one of the aforementioned examples 11 to 20.

Example 24 includes an apparatus comprising means to carry out operations according to any one of the aforementioned examples 11 to 20.

Example 25 includes a computing device arranged to carry out operations according to any one of the aforementioned examples 11 to 20.

Example 26 includes a communications device arranged to carry out operations according to any one of the aforementioned examples 11 to 20.

Some embodiments pertain to Example 27 that includes a system comprising a storage device having instructions, and a processor to execute the instructions to facilitate a mechanism to perform one or more operations comprising: selecting, at a computing device, a canned message from a plurality of canned messages, wherein the canned message includes a text message having one or more of a default message, a variable, and a symbol, wherein the selection is to be performed without a keyboard at the computing device; and transmitting the selected canned message.

Example 28 includes the subject matter of Example 27, wherein the computing device comprises one or more of a wearable computing device or a mobile computing device, wherein the wearable computing device includes one or more of a watch, a bracelet, a smartphone, a smart badge, a pair of glasses, a headset, a necklace, and a clothing item, and wherein the mobile computing device includes one or more of a smartphone, a tablet computer, and a laptop computer.

Example 29 includes the subject matter of Example 27, wherein the canned message further comprises an audio message or a video canned message, and further comprising selecting or recording the audio message or the video message.

Example 30 includes the subject matter of Example 27, wherein one or more operations comprise selecting the default message from a plurality of default messages, and the variable from a plurality of variables, wherein the variable is to be added to the default message.

Example 31 includes the subject matter of Example 30, wherein one or more operations comprise selecting the symbol from a plurality of symbols, wherein the symbol is to be added to the default message and the variable, the symbol including one or more of a punctuation mark, an emoticon, and an avatar.

Example 32 includes the subject matter of Example 31, wherein the canned message is to be transmitted in response to an incoming message, wherein the incoming message is received prior to the selection of the canned message.

Example 33 includes the subject matter of Example 30, wherein one or more operations comprise editing the plurality of default messages or the plurality of variables, wherein editing includes deleting or modifying the plurality of default messages and the plurality of variables, and wherein editing further includes adding one or more default messages to the plurality of default messages or one or more variables to the plurality of variables.

Example 34 includes the subject matter of Example 33, wherein editing further comprises editing the plurality of symbols, wherein editing includes deleting or modifying the plurality of symbols, and wherein editing further includes adding one or more symbols to the plurality of symbols.

Example 35 includes the subject matter of Example 27, wherein one or more operations comprise determining a preferred canned message to be selected and transmitted in response to the incoming message, wherein determining includes detecting one or more of user preferences, user history, sender-user identification, sending-computing device identification, language sensitivity of the incoming message, time sensitivity relating to the incoming message, context relating to the incoming message, and content of the incoming message.

Example 36 includes the subject matter of Example 35, wherein one or more operations comprise: corresponding one or more of the canned messages to one or more of the incoming messages; and facilitating selection and transmission of a preferred canned message in response to a corresponding incoming message.

Some embodiments pertain to Example 37 that includes an apparatus comprising: means for selecting, at a computing device, a canned message from a plurality of canned messages, wherein the canned message includes a text message having one or more of a default message, a variable, and a symbol, wherein the selection is to be performed without a keyboard at the computing device; and means for transmitting the selected canned message.

Example 38 includes the subject matter of Example 37, wherein the computing device comprises one or more of a wearable computing device or a mobile computing device, wherein the wearable computing device includes one or more of a watch, a bracelet, a smartphone, a smart badge, a pair of glasses, a headset, a necklace, and a clothing item, and wherein the mobile computing device includes one or more of a smartphone, a tablet computer, and a laptop computer.

Example 39 includes the subject matter of Example 37, wherein the canned message further comprises an audio message or a video canned message, and further comprising selecting or recording the audio message or the video message.

Example 40 includes the subject matter of Example 37, further comprising means for selecting the default message from a plurality of default messages, and the variable from a plurality of variables, wherein the variable is to be added to the default message.

Example 41 includes the subject matter of Example 40, further comprising means for selecting the symbol from a plurality of symbols, wherein the symbol is to be added to the default message and the variable, the symbol including one or more of a punctuation mark, an emoticon, and an avatar.

Example 42 includes the subject matter of Example 41, wherein the canned message is to be transmitted in response to an incoming message, wherein the incoming message is received prior to the selection of the canned message.

Example 43 includes the subject matter of Example 40, further comprising means for editing the plurality of default messages or the plurality of variables, wherein editing includes deleting or modifying the plurality of default messages and the plurality of variables, and wherein editing further includes adding one or more default messages to the plurality of default messages or one or more variables to the plurality of variables.

Example 44 includes the subject matter of Example 43, wherein means for editing further comprises editing the plurality of symbols, wherein editing includes deleting or modifying the plurality of symbols, and wherein editing further includes adding one or more symbols to the plurality of symbols.

Example 45 includes the subject matter of Example 37, further comprising means for determining a preferred canned message to be selected and transmitted in response to the incoming message, wherein determining includes detecting one or more of user preferences, user history, sender-user identification, sending-computing device identification, language sensitivity of the incoming message, time sensitivity relating to the incoming message, context relating to the incoming message, and content of the incoming message.

Example 46 includes the subject matter of Example 45, further comprising: means for corresponding one or more of the canned messages to one or more of the incoming messages; and means for facilitating selection and transmission of a preferred canned message in response to a corresponding incoming message.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
message selection logic, at least a portion of which is implemented in hardware, to select, at the apparatus, a canned message from a plurality of canned messages, wherein the canned message includes a text message having one or more of a default message, a variable, and a symbol, wherein the selection is to be performed without a keyboard at the apparatus; and
logic, at least a portion of which is implemented in hardware, to transmit the selected canned message.

2. The apparatus of claim 1, comprises a computing device including one or more of a wearable computing device or a mobile computing device, wherein the wearable computing device includes one or more of a watch, a bracelet, a smartphone, a smart badge, a pair of glasses, a headset, a necklace, and a clothing item, and wherein the mobile computing device includes one or more of a smartphone, a tablet computer, and a laptop computer.

3. The apparatus of claim 1, wherein the canned message further comprises an audio message or a video canned message, and wherein the message selection logic comprises logic to select or record the audio message or the video message.

4. The apparatus of claim 1, wherein the message selection logic further comprises text selection logic, at least a portion of which is implemented in hardware, to select the default message from a plurality of default messages, wherein the text selection logic is further to select a value from a plurality of values associated with the variable from a plurality of variables, wherein the variable is to be added to the default message.

5. The apparatus of claim 4, wherein the message selection logic further comprises symbol selection logic, at least a portion of which is implemented in hardware, to select the symbol from a plurality of symbols, wherein the symbol is to be added to the default message and the variable, the symbol including one or more of a punctuation mark, an emoticon, and an avatar.

6. The apparatus of claim 1, wherein the canned message is to be transmitted in response to an incoming message, wherein the logic is further to receive the incoming message prior to the selection of the canned message.

7. The apparatus of claim 4, further comprising message customization logic comprising editing logic, at least a portion of which is implemented in hardware, to edit the plurality of default messages or the plurality of variables, wherein to edit includes to delete or modify the plurality of default messages and the plurality of variables, and wherein to edit further includes to add one or more default messages to the plurality of default messages or one or more variables to the plurality of variables.

8. The apparatus of claim 7, wherein the editing logic is further to edit the plurality of symbols, wherein editing includes deleting or modifying the plurality of symbols, and wherein editing further includes adding one or more symbols to the plurality of symbols.

9. The apparatus of claim 7, wherein the message customization logic further comprises dynamic preference logic, at least a portion of which is implemented in hardware, to determine a preferred canned message to be selected and transmitted in response to the incoming message, wherein to determine includes to detect one or more of user preferences, user history, sender-user identification, sending-computing device identification, language sensitivity of the incoming messages, time sensitivity relating to the incoming messages, context relating to the incoming message, and content of the incoming message.

10. The apparatus of claim 9, wherein the dynamic preference logic is further to correspond one or more of the canned messages to one or more of the incoming messages, and wherein the dynamic preference logic is further to facilitate the message selection logic to select and transmit a preferred canned message in response to a corresponding incoming message.

11. At least one machine-readable medium comprising a plurality of instructions that in response to being executed on a computing device, causes the computing device to carry out one or more operations comprising:
selecting, at a computing device, a canned message from a plurality of canned messages, wherein the canned message includes a text message having one or more of a default message, a variable, and a symbol, wherein the selection is to be performed without a keyboard at the computing device; and
transmitting the selected canned message.

12. The machine-readable medium of claim 11, wherein the computing device comprises one or more of a wearable computing device or a mobile computing device, wherein the wearable computing device includes one or more of a watch, a bracelet, a smartphone, a smart badge, a pair of glasses, a headset, a necklace, and a clothing item, and wherein the mobile computing device includes one or more of a smartphone, a tablet computer, and a laptop computer.

13. The machine-readable medium of claim 11, wherein the canned message further comprises an audio message or a video canned message, and further comprising selecting or recording the audio message or the video message.

14. The machine-readable medium of claim 11, wherein the one or more operations further comprise selecting the default message from a plurality of default messages, and the variable from a plurality of variables, wherein the variable is to be added to the default message.

15. The machine-readable medium of claim 14, wherein the one or more operations further comprise selecting the symbol from a plurality of symbols, wherein the symbol is to be added to the default message and the variable, the symbol including one or more of a punctuation mark, an emoticon, and an avatar.

16. The machine-readable medium of claim 11, wherein the canned message is to be transmitted in response to an incoming message, wherein the incoming message is received prior to the selection of the canned message.

17. The machine-readable medium of claim 14, wherein the one or more operations further comprise editing the plurality of default messages or the plurality of variables, wherein editing includes deleting or modifying the plurality of default messages and the plurality of variables, and wherein editing further includes adding one or more default messages to the plurality of default messages or one or more variables to the plurality of variables.

18. The machine-readable medium of claim 17, wherein editing further comprises editing the plurality of symbols, wherein editing includes deleting or modifying the plurality of symbols, and wherein editing further includes adding one or more symbols to the plurality of symbols.

19. The machine-readable medium of claim 11, wherein the one or more operations further comprise determining a preferred canned message to be selected and transmitted in response to the incoming message, wherein determining includes detecting one or more of user preferences, user history, sender-user identification, sending-computing device identification, language sensitivity of the incoming message, time sensitivity relating to the incoming message, context relating to the incoming message, and content of the incoming message.

20. The machine-readable medium of claim 19, wherein the one or more operations further comprise:
corresponding one or more of the canned messages to one or more of the incoming messages; and
facilitating selection and transmission of a preferred canned message in response to a corresponding incoming message.

21. A method comprising:
selecting, at a computing device, a canned message from a plurality of canned messages, wherein the canned message includes a text message having one or more of a default message, a variable, and a symbol, wherein the selection is to be performed without a keyboard at the computing device; and
transmitting the selected canned message.

22. The method of claim 21, wherein the computing device comprises one or more of a wearable computing device or a mobile computing device, wherein the wearable computing device includes one or more of a watch, a bracelet, a smartphone, a smart badge, a pair of glasses, a headset, a necklace, and a clothing item, and wherein the mobile computing device includes one or more of a smartphone, a tablet computer, and a laptop computer,
wherein the canned message further comprises an audio message or a video canned message, and further comprising selecting or recording the audio message or the video message.

23. The method of claim 21, further comprising:
selecting the default message from a plurality of default messages, and the variable from a plurality of variables, wherein the variable is to be added to the default message; and
selecting the symbol from a plurality of symbols, wherein the symbol is to be added to the default message and the variable, the symbol including one or more of a punctuation mark, an emoticon, and an avatar,
wherein the canned message is to be transmitted in response to an incoming message, wherein the incoming message is received prior to the selection of the canned message.

24. The method of claim 23, further comprising:
editing the plurality of default messages or the plurality of variables, wherein editing includes deleting or modifying the plurality of default messages and the plurality of variables, and wherein editing further includes adding one or more default messages to the plurality of default messages or one or more variables to the plurality of variables,
wherein editing further comprises editing the plurality of symbols, wherein editing includes deleting or modifying the plurality of symbols, and wherein editing further includes adding one or more symbols to the plurality of symbols.

25. The method of claim 21, further comprising:
determining a preferred canned message to be selected and transmitted in response to the incoming message, wherein determining includes detecting one or more of user preferences, user history, sender-user identification, sending-computing device identification, language sensitivity of the incoming message, time sensitivity relating to the incoming message, context relating to the incoming message, and content of the incoming message;
corresponding one or more of the canned messages to one or more of the incoming messages; and
facilitating selection and transmission of a preferred canned message in response to a corresponding incoming message.
